(19) United States
(12) Patent Application Publication
(10) Pub. No.: US 2019/0283752 A1
(43) Pub. Date: Sep. 19, 2019

(54) VEHICLE CONTROL DEVICE AND VEHICLE CONTROL METHOD

(71) Applicant: HONDA MOTOR CO., LTD., TOKYO (JP)

(72) Inventors: Suguru YANAGIHARA, WAKO-SHI (JP); Hiroshi MIURA, WAKO-SHI (JP); Yuta TAKADA, TOKYO (JP)

(21) Appl. No.: 16/352,472

(22) Filed: Mar. 13, 2019

(30) Foreign Application Priority Data
Mar. 14, 2018 (JP) 2018-046223

(51) Int. Cl. B60W 30/18

(52) U.S. Cl. CPC B60W 30/181; B60W 2420/42; B60W 2420/52; B60W 2720/106; B60W 2550/30; B60W 2550/14; B60W 2720/10; B60W 2550/22

(57) ABSTRACT

A vehicle control device that automatically performs travel control of a host vehicle includes: a construction area acquisition unit that acquires a construction area in an opposite lane ahead of the host vehicle; a target stop position setting unit that, if the construction area is present in the opposite lane ahead of the host vehicle, sets a target stop position where the host vehicle stops before the construction area, in accordance with at least one piece of information among an avoidance trajectory of an oncoming vehicle, the type of the oncoming vehicle, and the vehicle speed of the oncoming vehicle; and a travel control unit that controls acceleration and deceleration of the host vehicle so that the host vehicle stops at the set target stop position.

### CROSS-REFERENCE TO RELATED APPLICATION

This application is based upon and claims the benefit of priority from Japanese Patent Application No. 2018-046223 filed on Mar. 14, 2018, the contents of which are incorporated herein by reference.

### BACKGROUND OF THE INVENTION

### Field of the Invention

The present invention relates to a vehicle control device and a vehicle control method for performing travel control of a host vehicle automatically at least partially.

### Description of the Related Art

According to the disclosure in Japanese Laid-Open Patent Publication No. 2005-202678, if there is an obstacle in a travel path for a host vehicle, a recommended stop position is set at a position that is separated from a position of the obstacle toward the host vehicle by a predetermined distance, and recommended stop point instruction information is displayed in an overlapping manner at the recommended stop position in a foreground of a head mount display.

### SUMMARY OF THE INVENTION

In the technique according to Japanese Laid-Open Patent Publication No. 2005-202678, the recommended stop position is set before the obstacle (construction area) and the recommended stop position is displayed in the head mount display; however, controlling the host vehicle so as to stop at the recommended stop position has not been disclosed.

The present invention has been made in view of the above circumstance, and an object is to provide a vehicle control device and a vehicle control method that can, if there is a construction area ahead of a host vehicle, stop the host vehicle as appropriate before the construction area.

A vehicle control device according to a first aspect of the present invention is a vehicle control device configured to perform travel control of a host vehicle automatically at least partially and including: a construction area acquisition unit configured to acquire a construction area in an opposite lane ahead of the host vehicle; an oncoming vehicle state acquisition unit configured to acquire at least one piece of information among an avoidance trajectory along which an oncoming vehicle avoids the construction area, a type of the oncoming vehicle, and a vehicle speed of the oncoming vehicle; a target stop position setting unit configured to, if the construction area is present in the opposite lane ahead of the host vehicle, set a target stop position where the host vehicle stops before the construction area, in accordance with the acquired at least one piece of information among the avoidance trajectory of the oncoming vehicle, the type of the oncoming vehicle, and the vehicle speed of the oncoming vehicle; and a travel control unit configured to control acceleration and deceleration of the host vehicle so that the host vehicle stops at the set target stop position. Thus, the vehicle control device can stop the host vehicle before the construction area at the position where travel of the oncoming vehicle is not interrupted.

A vehicle control device according to a second aspect of the present invention is a vehicle control device configured to perform travel control of a host vehicle automatically at least partially and including: a construction area acquisition unit configured to acquire a construction area in an opposite lane ahead of the host vehicle; a construction area shape acquisition unit configured to acquire a shape of the construction area; a target stop position setting unit configured to, if the construction area is present in the opposite lane ahead of the host vehicle, set a target stop position where the host vehicle stops before the construction area, in accordance with the acquired shape of the construction area; and a travel control unit configured to control acceleration and deceleration of the host vehicle so that the host vehicle stops at the set target stop position. Thus, the vehicle control device can stop the host vehicle before the construction area at the position where the travel of the oncoming vehicle is not interrupted.

A vehicle control device according to a third aspect of the present invention is the aforementioned vehicle control device that may further include: a construction area shape acquisition unit configured to acquire a shape of the construction area; and a stop position display acquisition unit configured to acquire a stop position display showing a stop position before the construction area, wherein the target stop position setting unit may be configured to set the target stop position, in accordance with the acquired at least one piece of information among the avoidance trajectory of the oncoming vehicle, the type of the oncoming vehicle, the vehicle speed of the oncoming vehicle, and the shape of the construction area, on a basis of the stop position shown by the acquired stop position display. Thus, the vehicle control device can stop the host vehicle before the construction area at the position where the travel of the oncoming vehicle is not interrupted.

A vehicle control device according to a fourth aspect of the present invention is the aforementioned vehicle control device wherein the target stop position setting unit may be configured to set the target stop position so that a distance between the construction area and the target stop position is longer, as the acquired type of the oncoming vehicle is larger, or the acquired vehicle speed of the oncoming vehicle is higher. Thus, the vehicle control device can stop the host vehicle before the construction area, in accordance with the type or the vehicle speed of the oncoming vehicle at the position where the travel of the oncoming vehicle is not interrupted.

A vehicle control device according to a fifth aspect of the present invention is the aforementioned vehicle control device wherein the target stop position setting unit may be configured to set the target stop position so that a distance between the construction area and the target stop position is longer, as the oncoming vehicles passing by the host vehicle include more large automobiles before the host vehicle reaches the construction area. Thus, the host vehicle can be stopped at the position where the travel of the oncoming vehicle that is the large automobile is not interrupted.

A vehicle control device according to a sixth aspect of the present invention is the aforementioned vehicle control device that may further include a construction area shape acquisition unit configured to acquire a shape of the construction area, wherein the target stop position setting unit may be configured to set the target stop position in a width direction of an own lane, in accordance with the acquired at least one piece of information among the avoidance trajectory of the oncoming vehicle, the type of the oncoming vehicle, the vehicle speed of the oncoming vehicle, and the shape of the construction area. Thus, the vehicle control device can stop the host vehicle at the position where the travel of the oncoming vehicle is not interrupted while allowing the host vehicle to get as close to the construction area as possible in a length direction of the own lane.

A vehicle control device according to a seventh aspect of the present invention is the aforementioned vehicle control device that may further include a stop position display acquisition unit configured to acquire a stop position display showing a stop position before the construction area, wherein if the stop position display is acquired, the target stop position setting unit may be configured to set the stop position shown by the acquired stop position display as the target stop position. Thus, the vehicle control device can stop the host vehicle at the stop position shown by the stop position display.

A vehicle control method according to an eighth aspect of the present invention is a vehicle control method for performing travel control of a host vehicle automatically at least partially, including: a construction area acquisition step of acquiring a construction area in an opposite lane ahead of the host vehicle; an oncoming vehicle state acquisition step of acquiring at least one piece of information among an avoidance trajectory along which the oncoming vehicle avoids the construction area, a type of the oncoming vehicle, and a vehicle speed of the oncoming vehicle; a target stop position setting step of, if the construction area is present in the opposite lane ahead of the host vehicle, setting a target stop position where the host vehicle stops before the construction area, in accordance with the acquired at least one piece of information among the avoidance trajectory of the oncoming vehicle, the type of the oncoming vehicle, and the vehicle speed of the oncoming vehicle; and a travel control step of controlling acceleration and deceleration of the host vehicle so that the host vehicle stops at the set target stop position. By this vehicle control method, the host vehicle can be stopped before the construction area at the position where the travel of the oncoming vehicle is not interrupted.

A vehicle control method according to a ninth aspect of the present invention is a vehicle control method for performing travel control of a host vehicle automatically at least partially, including: a construction area acquisition step of acquiring a construction area in an opposite lane ahead of the host vehicle; a construction area shape acquisition step of acquiring a shape of the construction area; a target stop position setting step of, if the construction area is present in the opposite lane ahead of the host vehicle, setting a target stop position where the host vehicle stops before the construction area, in accordance with the acquired shape of the construction area; and a travel control step of controlling acceleration and deceleration of the host vehicle so that the host vehicle stops at the set target stop position. By this vehicle control method, the host vehicle can be stopped before the construction area at the position where the travel of the oncoming vehicle is not interrupted.

A vehicle control method according to a tenth aspect of the present invention is the aforementioned vehicle control method that may further include a construction area shape acquisition step of acquiring a shape of the construction area; and a stop position display acquisition step of acquiring a stop position display showing a stop position before the construction area, wherein in the target stop position setting step, the target stop position may be set, in accordance with the acquired at least one piece of information among the avoidance trajectory of the oncoming vehicle, the type of the oncoming vehicle, the vehicle speed of the oncoming vehicle, and the shape of the construction area, on a basis of the stop position shown by the acquired stop position display. By this vehicle control method, the host vehicle can be stopped before the construction area at the position where the travel of the oncoming vehicle is not interrupted.

A vehicle control method according to an eleventh aspect of the present invention is the aforementioned vehicle control method wherein in the target stop position setting step, the target stop position may be set so that a distance between the construction area and the target stop position is longer, as the acquired type of the oncoming vehicle is larger, or the acquired vehicle speed of the oncoming vehicle is higher. By this vehicle control method as the acquired type of the oncoming vehicle is larger, or the acquired vehicle speed of the oncoming vehicle is higher, the host vehicle can be stopped before the construction area, in accordance with the type or the vehicle speed of the oncoming vehicle at the position where the travel of the oncoming vehicle is not interrupted.

A vehicle control method according to a twelfth aspect of the present invention is the aforementioned vehicle control method wherein in the target stop position setting step, the target stop position may be set so that a distance between the construction area and the target stop position is longer, as the oncoming vehicles passing by the host vehicle include more large automobiles before the host vehicle reaches the construction area. Thus, the host vehicle can be stopped at the position where the travel of the oncoming vehicle that is the large automobile is not interrupted.

A vehicle control method according to a thirteenth aspect of the present invention is the aforementioned vehicle control method that may further include a construction area shape acquisition step of acquiring a shape of the construction area, wherein in the target stop position setting step, the target stop position in a width direction of an own lane may be set, in accordance with the acquired at least one piece of information among the avoidance trajectory of the oncoming vehicle, the type of the oncoming vehicle, the vehicle speed of the oncoming vehicle, and the shape of the construction area. By this vehicle control method, the host vehicle can be stopped at the position where the travel of the oncoming vehicle is not interrupted while the host vehicle is allowed to get as close to the construction area as possible in the length direction of the own lane.

A vehicle control method according to a fourteenth aspect of the present invention is the aforementioned vehicle control method that may further include a stop position display acquisition step of acquiring a stop position display showing a stop position before the construction area, wherein if the stop position display is acquired, the stop position shown by the acquired stop position display may be set as the target stop position in the target stop position setting step. By this vehicle control method, the host vehicle can be stopped at the stop position shown by the stop position display.

By the vehicle control device and the vehicle control method according to the present invention, the host vehicle can be stopped before the construction area at the position where the travel of the oncoming vehicle is not interrupted.

The above and other objects, features, and advantages of the present invention will become more apparent from the following description when taken in conjunction with the accompanying drawings in which a preferred embodiment of the present invention is shown by way of illustrative example.

### BRIEF DESCRIPTION OF THE DRAWINGS

FIG. 1 is a schematic view illustrating a circumstance of a road where vehicles travel in accordance with one-side alternate traffic due to a road construction;

FIG. 2 is a block diagram illustrating a configuration of a vehicle control device;

FIG. 3 is a function block diagram of a calculation device;

FIGS. 4A, 4B, and 4C are schematic views each illustrating an example of the shape of the construction area;

FIG. 5 is a flowchart showing a vehicle stop control process to be performed in the vehicle control device;

FIG. 6 is a flowchart showing the vehicle stop control process to be performed in the vehicle control device;

FIG. 7 is a flowchart showing the vehicle stop control process to be performed in the vehicle control device; and

FIG. 8 is a flowchart showing the vehicle stop control process to be performed in the vehicle control device.

### DESCRIPTION OF THE PREFERRED EMBODIMENTS

### First Embodiment

### [One-Side Alternate Traffic in Construction Area]

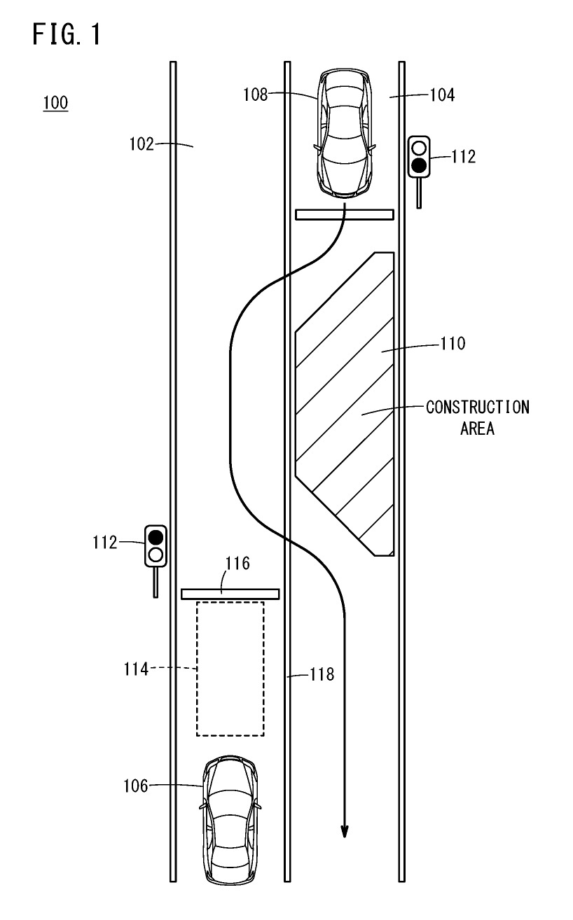

FIG. 1 is a schematic view illustrating a circumstance of a road 100 where vehicles travel in accordance with one-side alternate traffic due to a road construction. In a state illustrated in FIG. 1, the road construction is performed ahead of a host vehicle 106 in an opposite lane 104 of the road 100 with a single lane on each side. An oncoming vehicle 108 travels in the opposite lane 104, and the host vehicle 106 travels in an own lane 102. When the oncoming vehicle 108 avoids a construction area 110, the oncoming vehicle 108 enters the own lane 102 once, and then after passing the construction area 110, returns to the opposite lane 104.

Before the construction area 110 in the own lane 102 and the opposite lane 104, a traffic control person is often disposed to instruct a driver in the host vehicle 106 or the oncoming vehicle 108 to stop. Instead of the traffic control person, a traffic light 112 may be disposed. In the case where the traffic control person instructs to stop or the traffic light 112 shows a signal expressing an instruction to stop, it is preferable that the host vehicle 106 stops.

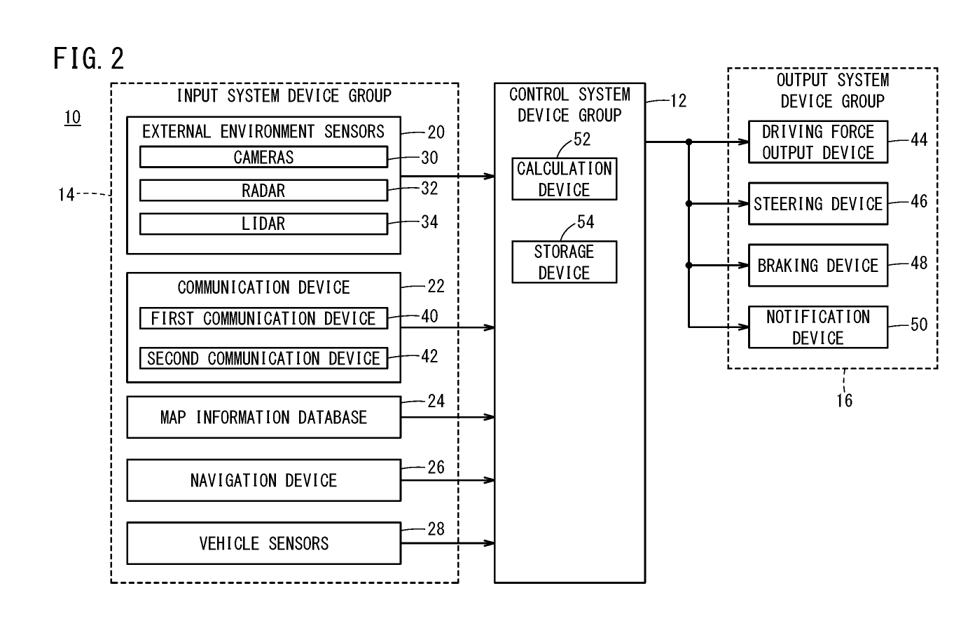

A vehicle control device 10 (FIG. 2) according to the present embodiment automatically performs travel control of the host vehicle 106. On the road 100 of the one-side alternate traffic due to the road construction or the like, the vehicle control device 10 stops the host vehicle 106 before the construction area 110 on the basis of the instruction of the stop by the traffic control person or the traffic light 112. Here, the vehicle control device 10 sets a target stop position 114 to stop the host vehicle 106 at a position where passing of the oncoming vehicle 108 is not interrupted, and controls acceleration and deceleration of the host vehicle 106 so that the host vehicle 106 stops at the target stop position 114.

### [Configuration of Vehicle Control Device]

FIG. 2 is a block diagram illustrating a configuration of the vehicle control device 10. The vehicle control device 10 is incorporated in the host vehicle 106, and performs automated driving control for the host vehicle 106. In the present embodiment, “automated driving” refers to not just “fully automated driving” in which the travel control of the vehicle is performed fully automatically but also “partially automated driving” in which the travel control is performed partially automatically.

The vehicle control device 10 includes a control system device group 12 that collectively controls the driving of the host vehicle 106, an input system device group 14 that performs an input function of the control system device group 12, and an output system device group 16 that performs an output function of the control system device group 12.

### <Configuration of Input System Device Group>

The input system device group 14 includes: external environment sensors 20 that detect a state of a periphery (external environment) of the vehicle; a communication device 22 that exchanges information with various communication devices outside the vehicle; a map information database 24 that acquires map information expressing a high-precision map; a navigation device 26 that generates a travel route to a destination and measures a travel position of the vehicle; and vehicle sensors 28 that detect a state of the host vehicle 106.

The external environment sensors 20 include one or more cameras 30 that capture images of the external environment, one or more radars 32 and one or more LIDARs 34 (Light Detection and Ranging, or Laser Imaging Detection and Ranging) that detect the distance and the relative speed between the host vehicle 106 and another object.

The communication device 22 includes a first communication device 40 that performs vehicle-vehicle communication between the host vehicle and another vehicle, and a second communication device 42 that performs road-vehicle communication between the host vehicle and a road-side device.

The navigation device 26 includes a satellite navigation system and a self-contained navigation system. The vehicle sensors 28 include various sensors that detect a behavior of the vehicle, such as a vehicle speed sensor, an acceleration sensor, a yaw rate sensor, and an inclination sensor, various sensors that detect an operation state of the vehicle, and various sensors that detect a state of a driver.

### <Configuration of Output System Device Group>

The output system device group 16 includes a driving force output device 44, a steering device 46, a braking device 48, and a notification device 50.

The driving force output device 44 includes a driving force output electronic control unit (ECU), and a driving source such as an engine or a traction motor. The driving force output device 44 generates the driving force in response to a driver's operation on an accelerator pedal or a driving control instruction that is output from the control system device group 12.

The steering device 46 includes an electric power steering system (EPS)-ECU, and an EPS actuator. The steering device 46 generates a steering force in response to a driver's operation on a steering wheel or a steering control instruction that is output from the control system device group 12.

The braking device 48 includes a braking ECU and a braking actuator. The braking device 48 generates a braking force in response to a driver's operation on a braking pedal or a braking control instruction that is output from the control system device group 12.

The notification device 50 includes a notification ECU and an information transmission device (such as a display device, an audio device, or a haptic device). The notification device 50 notifies a driver in response to a notification instruction that is output from the control system device group 12 or another ECU (for example, provides information through any of five senses including visual and auditory senses).

### <Configuration of Control System Device Group>

The control system device group 12 includes one or more ECUs, and includes a calculation device 52 such as a processor and a storage device 54 such as a ROM or a RAM. The control system device group 12 achieves various functions when the calculation device 52 executes programs stored in the storage device 54.

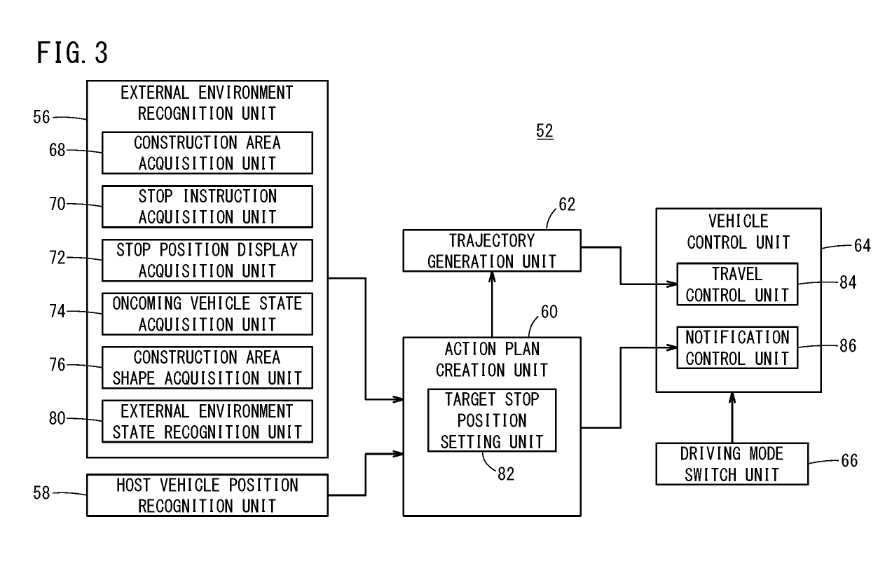

FIG. 3 is a function block diagram of the calculation device 52. This calculation device 52 is configured to be able to perform various functions of an external environment recognition unit 56, a host vehicle position recognition unit 58, an action plan creation unit 60, a trajectory generation unit 62, a vehicle control unit 64, and a driving mode switch unit 66.

The external environment recognition unit 56 recognizes a circumstance and an object around the vehicle on the basis of the information output from the external environment sensors 20. This external environment recognition unit 56 includes a construction area acquisition unit 68, a stop instruction acquisition unit 70, a stop position display acquisition unit 72, an oncoming vehicle state acquisition unit 74, a construction area shape acquisition unit 76, and an external environment state recognition unit 80.

The construction area acquisition unit 68 acquires the construction area 110 ahead of the host vehicle 106 on the basis of image information from the cameras 30. The construction area acquisition unit 68 acquires the construction area 110 after distinguishing whether the construction area 110 is in the own lane 102 or in the opposite lane 104. Note that, for example, the construction area acquisition unit 68 may acquire the construction area 110 ahead of the host vehicle 106 from the first communication device 40 that performs the vehicle-vehicle communication or the second communication device 42 that performs the road-vehicle communication.

The stop instruction acquisition unit 70 acquires the stop instruction from the traffic control person disposed before the construction area 110 or the traffic light 112 disposed before the construction area 110 on the basis of the image information from the cameras 30. The stop instruction acquisition unit 70 analyzes the motion of a handflag, a traffic wand, or the like of the traffic control person, and acquires the stop instruction for the traffic in the own lane 102. In addition, the stop instruction acquisition unit 70 analyzes the signal displayed by the traffic light 112, and acquires the stop instruction for the traffic in the own lane 102. Note that, for example, the stop instruction acquisition unit 70 may acquire the stop instruction from the first communication device 40 that performs the vehicle-vehicle communication or the second communication device 42 that performs the road-vehicle communication.

The stop position display acquisition unit 72 acquires a stop position display 116 provided before the construction area 110 on the basis of the image information from the cameras 30. The stop position display 116 is a white line drawn on the road surface of the own lane 102 as illustrated in FIG. 1. The stop position display 116 may be shown by a sign or the like with an instruction “STOP HERE” thereon, for example. Note that, for example, the stop position display acquisition unit 72 may acquire the stop position shown by the stop position display 116 from the first communication device 40 that performs the vehicle-vehicle communication or the second communication device 42 that performs the road-vehicle communication.

The oncoming vehicle state acquisition unit 74 acquires the state of the oncoming vehicle 108 on the basis of the image information from the cameras 30. The oncoming vehicle state acquisition unit 74, for example, estimates an avoidance trajectory along which the oncoming vehicle 108 travels to avoid the construction area 110, and acquires the avoidance trajectory as the state of the oncoming vehicle 108. In addition, the oncoming vehicle state acquisition unit 74 acquires the shape of the oncoming vehicle 108 as the state of the oncoming vehicle 108. The oncoming vehicle state acquisition unit 74 acquires the type of the oncoming vehicle 108, for example a large automobile, a middle-sized automobile, a standard automobile, or a motorcycle, from the shape of the oncoming vehicle 108. The type such as the large automobile, the middle-sized automobile, the standard automobile, or the motorcycle may be set depending on the vehicle width or length. In the present embodiment, the vehicle is set to become wider, longer, and larger in the order of the motorcycle, the standard automobile, the middle-sized automobile, and the large automobile. Note that the oncoming vehicle state acquisition unit 74 regularly acquires the type of the oncoming vehicle 108 during the travel of the host vehicle 106. Note that, for example, the oncoming vehicle state acquisition unit 74 may acquire the state of the oncoming vehicle 108 from the first communication device 40 that performs the vehicle-vehicle communication or the second communication device 42 that performs the road-vehicle communication.

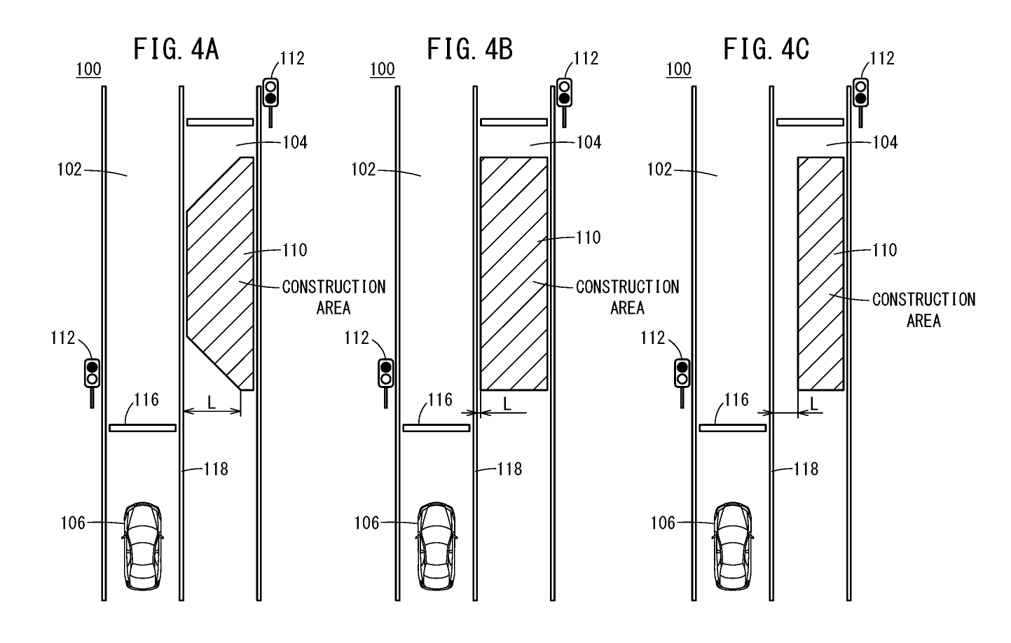

The construction area shape acquisition unit 76 acquires the shape of the construction area 110 on the basis of the image information from the cameras 30. FIG. 4A to FIG. 4C are schematic views each illustrating an example of the shape of the construction area 110. In the example illustrated in FIG. 4A, the construction area 110 is provided in a manner that a side surface of the construction area 110 on the host vehicle 106 side is inclined with respect to the width direction of the opposite lane 104 and the side surface is separated from the own lane 102 in a direction from the far side to the host vehicle 106 side. In the example illustrated in FIG. 4B, the construction area 110 is provided in a manner that the side surface of the construction area 110 on the host vehicle 106 side is substantially parallel to the width direction of the opposite lane 104. In the example illustrated in FIG. 4C, the construction area 110 is provided entirely on the shoulder side of the road in the width direction of the opposite lane 104.

The construction area shape acquisition unit 76 acquires, for example, a distance L between a part of the construction area 110 on the host vehicle 106 side and a center line 118 of the road 100 as the shape of the construction area 110. In addition, the construction area acquisition unit 68 acquires the angle of the side surface of the construction area 110 on the host vehicle 106 side with respect to the width direction of the opposite lane 104, the ratio of the construction area 110 to the opposite lane 104 in the width direction, or the like. Note that, for example, the construction area shape acquisition unit 76 may acquire the shape of the construction area 110 from the first communication device 40 that performs the vehicle-vehicle communication or the second communication device 42 that performs the road-vehicle communication.

For example, the external environment state recognition unit 80 recognizes an overall road environment, such as the shape and the width of the road, the position of a lane mark, the number and the width of the lane, the color of the traffic light, the open/close state of a crossing gate, and the like on the basis of the image information among the cameras 30 or the map information read out from the map information database 24.

The host vehicle position recognition unit 58 recognizes the absolute position of the host vehicle 106 or the relative position on the high-precision map (hereinafter also referred to as host vehicle position) on the basis of the map information database 24 and the information output from the navigation device 26.

The action plan creation unit 60 creates an action plan in accordance with the circumstance of the vehicle (time series of events for each travel section) on the basis of the recognition results from the external environment recognition unit 56 and the host vehicle position recognition unit 58, and updates the content of the action plan as necessary.

The action plan creation unit 60 includes a target stop position setting unit 82. The target stop position setting unit 82 sets the target stop position 114 corresponding to the position where the host vehicle 106 stops before the construction area 110 (FIG. 1). The target stop position 114 will be described below.

The trajectory generation unit 62 generates a travel trajectory (time series of target behaviors) in accordance with the action plan created by the action plan creation unit 60 on the basis of the recognition results from the external environment recognition unit 56 and the host vehicle position recognition unit 58.

The vehicle control unit 64 instructs the output system device group 16 (FIG. 2) to operate on the basis of the creation result from the action plan creation unit 60 or the generation result from the trajectory generation unit 62. The vehicle control unit 64 includes a travel control unit 84 that performs the travel control of the vehicle, and a notification control unit 86 that performs notification control for the driver.

The driving mode switch unit 66 is configured to be able to switch a plurality of driving modes including “automated driving mode” and “manual driving mode” in accordance with a driver's predetermined action (for example, operation of input device including switch and steering wheel). A request action from the driver to make a transition from the automated driving to the manual driving is also referred to as “takeover request (TOR: Take Over Request)”.

### [Vehicle Stop Control Process]

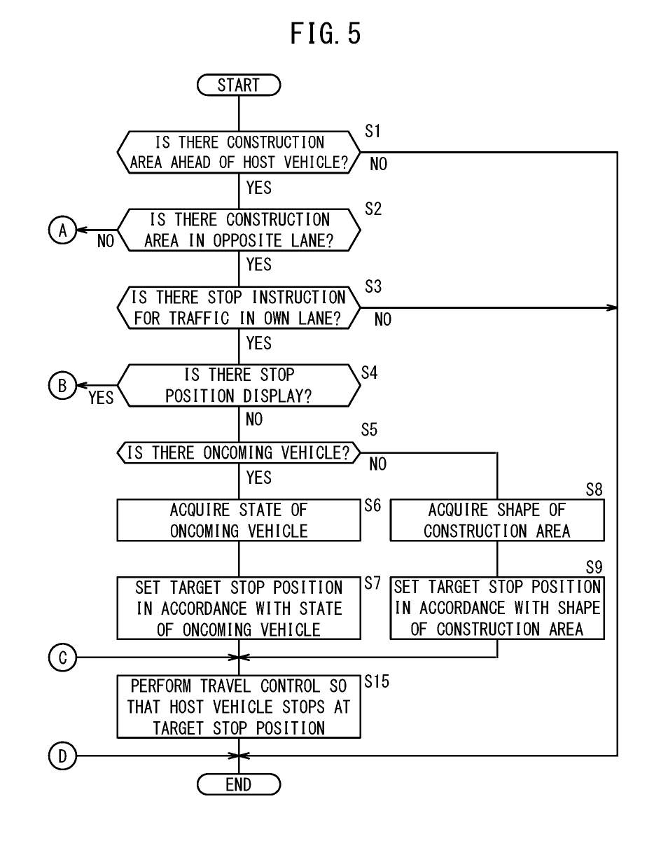

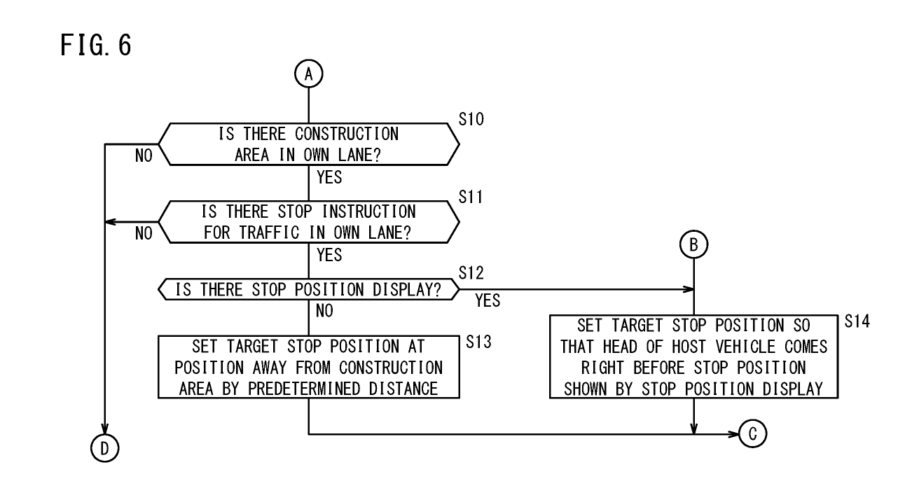

A vehicle stop control process before the construction area 110, which is performed in the vehicle control device 10 according to the present embodiment, is described. FIG. 5 and FIG. 6 are flowcharts showing the vehicle stop control process to be performed in the vehicle control device 10.

In step S1, the target stop position setting unit 82 determines whether the construction area acquisition unit 68 has acquired the construction area 110 ahead of the host vehicle 106. If the construction area 110 is present ahead of the host vehicle 106, the process advances to step S2, and if there is not the construction area 110 ahead of the host vehicle 106, the process ends.

In step S2, the target stop position setting unit 82 determines whether the construction area acquisition unit 68 has acquired the construction area 110 in the opposite lane 104. If the construction area 110 is present in the opposite lane 104, the process advances to step S3, and if there is not the construction area 110 in the opposite lane 104, the process advances to step S10.

In step S3, the target stop position setting unit 82 determines whether the stop instruction acquisition unit 70 has acquired the stop instruction for the traffic in the own lane 102. If the stop instruction for the traffic is present in the own lane 102, the process advances to step S4, and if there is not the stop instruction for the traffic in the own lane 102, the process ends.

In step S4, the target stop position setting unit 82 determines whether the stop position display acquisition unit 72 has acquired the stop position display 116. If the stop position display 116 is present, the process advances to step S14, and if there is not the stop position display 116, the process advances to step S5.

In step S5, the target stop position setting unit 82 determines whether the oncoming vehicle state acquisition unit 74 has acquired the oncoming vehicle 108. If the oncoming vehicle 108 is present, the process advances to step S6, and if there is not the oncoming vehicle 108, the process advances to step S8.

In step S6, the oncoming vehicle state acquisition unit 74 acquires the state of the oncoming vehicle 108 and then, the process advances to step S7. As described above, the oncoming vehicle state acquisition unit 74 acquires as the state of the oncoming vehicle 108, for example, the avoidance trajectory along which the oncoming vehicle 108 travels to avoid the construction area 110, the type of the oncoming vehicle 108, the vehicle speed of the oncoming vehicle 108, or the like.

In step S7, the target stop position setting unit 82 sets the target stop position 114 in accordance with the state of the oncoming vehicle 108, and then the process advances to step S15. The target stop position setting unit 82 sets the target stop position 114 in accordance with the avoidance trajectory of the oncoming vehicle 108 so that the host vehicle 106 stops at the position where the travel of the oncoming vehicle 108 is not interrupted. Furthermore, the target stop position setting unit 82 sets the target stop position 114 so that the distance between the construction area 110 and the target stop position 114 is longer, as the type of the oncoming vehicle 108 is larger or the speed of the oncoming vehicle 108 is higher. The target stop position setting unit 82 sets the position of the own lane 102 in the length direction and the position of the own lane 102 in the width direction as the target stop position 114.

In addition, the target stop position setting unit 82 sets the target stop position 114 so that the distance between the construction area 110 and the target stop position 114 is longer, as the oncoming vehicles 108 passing by the host vehicle 106 include more large automobiles until the host vehicle 106 reaches the construction area 110 from a position away from the construction area 110 by a predetermined distance (for example, 500 m). The aforementioned predetermined distance is not limited to 500 m but may be another appropriate distance.

In step S8, the construction area shape acquisition unit 76 acquires the shape of the construction area 110 and then, the process advances to step S9. As described above, the construction area shape acquisition unit 76 acquires, as the shape of the construction area 110, the distance L between the part of the construction area 110 on the host vehicle 106 side and the center line 118 of the road 100, the angle of the side surface of the construction area 110 on the host vehicle 106 side with respect to the width direction of the opposite lane 104, the ratio of the construction area 110 to the opposite lane 104 in the width direction, or the like.

In step S9, the target stop position setting unit 82 sets the target stop position 114 in accordance with the shape of the construction area 110, and then the process advances to step S15. The target stop position setting unit 82 sets the target stop position 114 in accordance with the shape of the construction area 110 so that the host vehicle 106 stops at the position where the travel of the oncoming vehicle 108 is not interrupted. The target stop position setting unit 82 sets the position of the own lane 102 in the length direction and the position of the own lane 102 in the width direction as the target stop position 114.

In addition, the target stop position setting unit 82 sets the target stop position 114 so that the distance between the construction area 110 and the target stop position 114 is longer, as the oncoming vehicles 108 passing by the host vehicle 106 include more large automobiles until the host vehicle 106 reaches the construction area 110 from the position away from the construction area 110 by the predetermined distance.

In step S10 after the condition in step S2 is denied, the target stop position setting unit 82 determines whether the construction area acquisition unit 68 has acquired the construction area 110 in the own lane 102. If the construction area 110 is present in the own lane 102, the process advances to step S11, and if there is not the construction area 110 in the own lane 102, the process ends.

In step S11, the target stop position setting unit 82 determines whether the stop instruction acquisition unit 70 has acquired the stop instruction for the traffic in the own lane 102. If the stop instruction for the traffic is present in the own lane 102, the process advances to step S12, and if there is not the stop instruction for the traffic in the own lane 102, the process ends.

In step S12, the target stop position setting unit 82 determines whether the stop position display acquisition unit 72 has acquired the stop position display 116. If the stop position display 116 is present, the process advances to step S14, and if there is not the stop position display 116, the process advances to step S13.

In step S13, the target stop position setting unit 82 sets the target stop position 114 at the position away from the construction area 110 by the predetermined distance, and then the process advances to step S15.

In step S14 after the condition in step S4 or step S12 is affirmed, the target stop position setting unit 82 sets the target stop position 114 so that the head of the host vehicle 106 comes right before the stop position display 116, and then the process advances to step S15.

In step S15 after the target stop position 114 is set in step S7, step S9, step S13, or step S14, the travel control unit 84 controls the acceleration and deceleration of the host vehicle 106 so that the host vehicle 106 stops at a position where the head of the host vehicle 106 comes to the target stop position 114. Then, the process ends.

### [Operation and Advantageous Effects]

If the opposite lane 104 is blocked by the construction area 110, vehicles may travel in accordance with the one-side alternate traffic. In the case of the one-side alternate traffic, the traffic control person is often disposed before the construction area 110 so as to instruct the driver of the host vehicle 106 or the oncoming vehicle 108 to stop. Instead of the traffic control person, the traffic light 112 may be disposed. In the case where the traffic control person instructs to stop or the traffic light 112 shows the signal expressing the instruction to stop, it is preferable that the host vehicle 106 stops.

The construction area 110 is disposed temporarily, and the stop position display 116 is not always disposed. Even if the stop position display 116 is not disposed, it is preferable that the host vehicle 106 is stopped at the appropriate position before the construction area 110. In particular, if the construction area 110 is present in the opposite lane 104, the oncoming vehicle 108 enters the own lane 102 where the host vehicle 106 travels once from the opposite lane 104 in order to avoid the construction area 110 and then, after passing the construction area 110, returns to the opposite lane 104; thus, depending on the stop position of the host vehicle 106, the travel of the oncoming vehicle 108 may be interrupted. Conventionally, the vehicle control device 10 that performs the automated driving in consideration of the stop position before the construction area 110 has not been provided.

In view of this, in the vehicle control device 10 according to the present embodiment, in the case where the construction area 110 is present in the opposite lane 104 ahead of the host vehicle 106, the target stop position setting unit 82 sets the target stop position 114 where the host vehicle 106 stops before the construction area 110 in accordance with at least one piece of information among the avoidance trajectory of the oncoming vehicle 108, the type of the oncoming vehicle 108, and the vehicle speed of the oncoming vehicle 108 that are acquired. In addition, the travel control unit 84 controls the acceleration and deceleration of the host vehicle 106 so that the host vehicle 106 stops at the set target stop position 114. Thus, the vehicle control device 10 can stop the host vehicle 106 before the construction area 110 at the position where the travel of the oncoming vehicle 108 is not interrupted.

In the vehicle control device 10 according to the present embodiment, in the case where the construction area 110 is present in the opposite lane 104 ahead of the host vehicle 106, the target stop position setting unit 82 sets the target stop position 114 where the host vehicle 106 stops before the construction area 110 in accordance with the acquired shape of the construction area 110. In addition, the travel control unit 84 controls the acceleration and deceleration of the host vehicle 106 so that the host vehicle 106 stops at the set target stop position 114. Thus, the vehicle control device 10 can stop the host vehicle 106 before the construction area 110 at the position where the travel of the oncoming vehicle 108 is not interrupted.

In the vehicle control device 10 according to the present embodiment, the target stop position setting unit 82 sets the target stop position 114 so that the distance between the construction area 110 and the target stop position 114 is longer, as the acquired type of the oncoming vehicle 108 is larger, or the acquired vehicle speed of the oncoming vehicle 108 is higher. Thus, the vehicle control device 10 can stop the host vehicle 106 before the construction area 110 at the position where the travel of the oncoming vehicle 108 is not interrupted in accordance with the type or the vehicle speed of the oncoming vehicle 108.

In the vehicle control device 10 according to the present embodiment, the target stop position setting unit 82 sets the target stop position 114 so that the distance between the construction area 110 and the target stop position 114 is longer, as the oncoming vehicles 108 passing by the host vehicle 106 include more large automobiles before the host vehicle 106 reaches the construction area 110. Thus, in a place where many large automobiles travel, the vehicle control device 10 can stop the host vehicle 106 at the position where the travel of the oncoming vehicle 108 that is the large automobile is not interrupted because the distance between the construction area 110 and the target stop position 114 is secured.

In the vehicle control device 10 according to the present embodiment, the target stop position setting unit 82 sets the target stop position 114 in the width direction of the own lane 102 in accordance with at least one piece of information among the avoidance trajectory of the oncoming vehicle 108, the type of the oncoming vehicle 108, the vehicle speed of the oncoming vehicle 108, and the shape of the construction area 110 that are acquired. Thus, the vehicle control device 10 can stop the host vehicle 106 at the position where the travel of the oncoming vehicle 108 is not interrupted while allowing the host vehicle 106 to get as close to the construction area 110 as possible in the length direction of the own lane 102.

In addition, in the vehicle control device 10 according to the present embodiment, in the case where the stop position display 116 is acquired, the target stop position setting unit 82 sets the target stop position 114 so that the head of the host vehicle 106 comes to the stop position shown by the stop position display 116. Thus, the vehicle control device 10 can stop the host vehicle 106 at the stop position shown by the stop position display 116.

### Second Embodiment

In the vehicle control device 10 according to the first embodiment, in the case where the stop position display 116 is present before the construction area 110, the target stop position setting unit 82 sets the target stop position 114 so that the head of the host vehicle 106 comes just before the stop position display 116. On the other hand, in the vehicle control device 10 according to a second embodiment, even in the case where the stop position display 116 is present before the construction area 110, the target stop position setting unit 82 sets the target stop position 114 in accordance with the state of the oncoming vehicle 108 or the shape of the construction area 110 on the basis of the stop position shown by the stop position display 116.

### [Vehicle Stop Control Process]

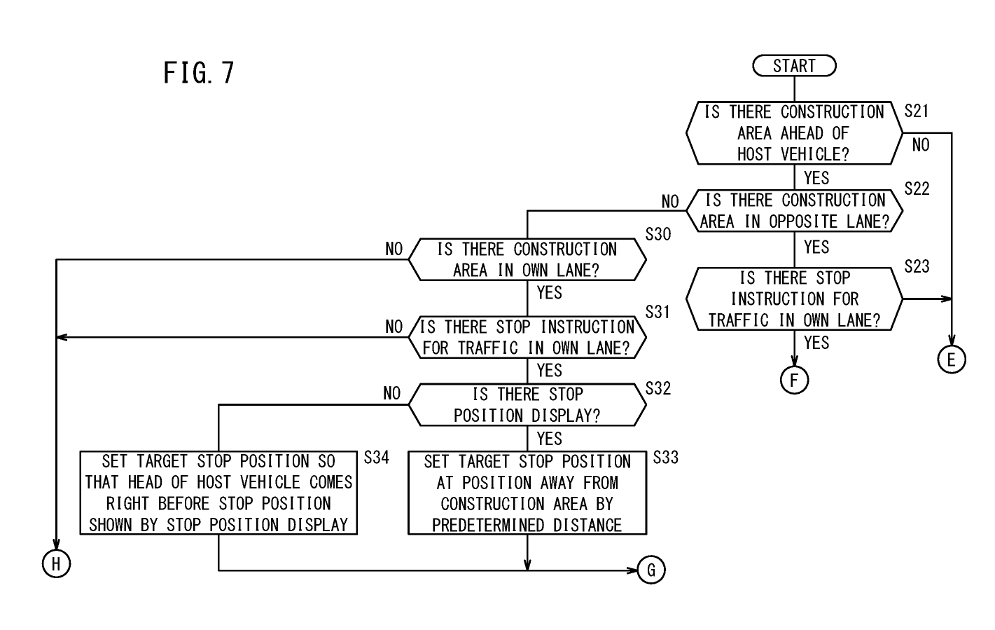

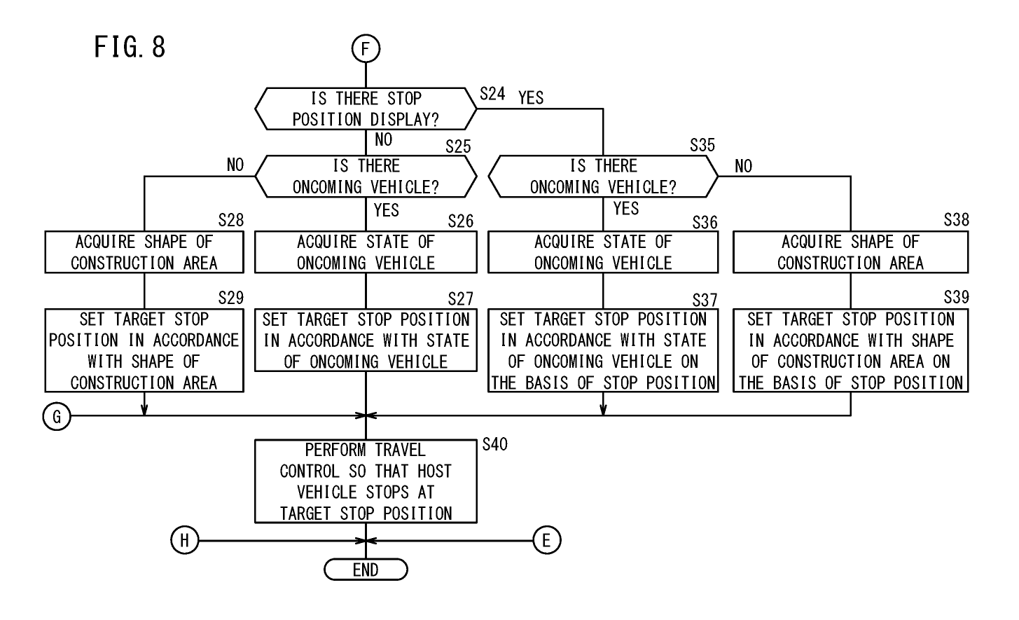

A vehicle stop control process before the construction area 110, which is performed in the vehicle control device 10 according to the present embodiment, is described. FIG. 7 and FIG. 8 are flowcharts showing the vehicle stop control process to be performed in the vehicle control device 10.

In step S21, the target stop position setting unit 82 determines whether the construction area acquisition unit 68 has acquired the construction area 110 ahead of the host vehicle 106. If the construction area 110 is present ahead of the host vehicle 106, the process advances to step S22, and if there is not the construction area 110 ahead of the host vehicle 106, the process ends.

In step S22, the target stop position setting unit 82 determines whether the construction area acquisition unit 68 has acquired the construction area 110 in the opposite lane 104. If the construction area 110 is present in the opposite lane 104, the process advances to step S23, and if there is not the construction area 110 in the opposite lane 104, the process advances to step S30.

In step S23, the target stop position setting unit 82 determines whether the stop instruction acquisition unit 70 has acquired the stop instruction for the traffic in the own lane 102. If the stop instruction for the traffic is present in the own lane 102, the process advances to step S24, and if there is not the stop instruction for the traffic in the own lane 102, the process ends.

In step S24, the target stop position setting unit 82 determines whether the stop position display acquisition unit 72 has acquired the stop position display 116. If the stop position display 116 is present, the process advances to step S35, and if there is not the stop position display 116, the process advances to step S25.

In step S25, the target stop position setting unit 82 determines whether the oncoming vehicle state acquisition unit 74 has acquired the oncoming vehicle 108. If the oncoming vehicle 108 is present, the process advances to step S26, and if there is not the oncoming vehicle 108, the process advances to step S28.

In step S26, the oncoming vehicle state acquisition unit 74 acquires the state of the oncoming vehicle 108 and then, the process advances to step S27. As described above, the oncoming vehicle state acquisition unit 74 acquires as the state of the oncoming vehicle 108, for example, the avoidance trajectory along which the oncoming vehicle 108 travels to avoid the construction area 110, the type of the oncoming vehicle 108, the vehicle speed of the oncoming vehicle 108, or the like.

In step S27, the target stop position setting unit 82 sets the target stop position 114 in accordance with the state of the oncoming vehicle 108, and then the process advances to step S40. The target stop position setting unit 82 sets the target stop position 114 in accordance with the avoidance trajectory of the oncoming vehicle 108 so that the host vehicle 106 stops at the position where the travel of the oncoming vehicle 108 is not interrupted. Furthermore, the target stop position setting unit 82 sets the target stop position 114 so that the distance between the construction area 110 and the target stop position 114 is longer, as the type of the oncoming vehicle 108 is larger or the speed of the oncoming vehicle 108 is higher. The target stop position setting unit 82 sets the position of the own lane 102 in the length direction and the position of the own lane 102 in the width direction as the target stop position 114.

In addition, the target stop position setting unit 82 sets the target stop position 114 so that the distance between the construction area 110 and the target stop position 114 is longer, as the oncoming vehicles 108 passing by the host vehicle 106 include more large automobiles until the host vehicle 106 reaches the construction area 110 from the position away from the construction area 110 by the predetermined distance.

In step S28, the construction area shape acquisition unit 76 acquires the shape of the construction area 110 and then, the process advances to step S29. As described above, the construction area shape acquisition unit 76 acquires, as the shape of the construction area 110, the distance L between the part of the construction area 110 on the host vehicle 106 side and the center line 118 of the road 100, the angle of the side surface of the construction area 110 on the host vehicle 106 side with respect to the width direction of the opposite lane 104, the ratio of the construction area 110 to the opposite lane 104 in the width direction, or the like.

In step S29, the target stop position setting unit 82 sets the target stop position 114 in accordance with the shape of the construction area 110, and then the process advances to step S40. The target stop position setting unit 82 sets the target stop position 114 in accordance with the shape of the construction area 110 so that the host vehicle 106 stops at the position where the travel of the oncoming vehicle 108 is not interrupted. The target stop position setting unit 82 sets the position of the own lane 102 in the length direction and the position of the own lane 102 in the width direction as the target stop position 114.

In addition, the target stop position setting unit 82 sets the target stop position 114 so that the distance between the construction area 110 and the target stop position 114 is longer, as the oncoming vehicles 108 passing by the host vehicle 106 include more large automobiles until the host vehicle 106 reaches the construction area 110 from the position away from the construction area 110 by the predetermined distance.

In step S30 after the condition in step S22 is denied, the target stop position setting unit 82 determines whether the construction area acquisition unit 68 has acquired the construction area 110 in the own lane 102. If the construction area 110 is present in the own lane 102, the process advances to step S31, and if there is not the construction area 110 in the own lane 102, the process ends.

In step S31, the target stop position setting unit 82 determines whether the stop instruction acquisition unit 70 has acquired the stop instruction for the traffic in the own lane 102. If the stop instruction for the traffic is present in the own lane 102, the process advances to step S32, and if there is not the stop instruction for the traffic in the own lane 102, the process ends.

In step S32, the target stop position setting unit 82 determines whether the stop position display acquisition unit 72 has acquired the stop position display 116. If the stop position display 116 is present, the process advances to step S33, and if there is not the stop position display 116, the process advances to step S34.

In step S33, the target stop position setting unit 82 sets the target stop position 114 at the position away from the construction area 110 by the predetermined distance, and then the process advances to step S40. In step S34, the target stop position setting unit 82 sets the target stop position 114 so that the head of the host vehicle 106 comes just before the stop position display 116. Then, the process advances to step S40.

In step S35 after the condition in step S24 is affirmed, the target stop position setting unit 82 determines whether the oncoming vehicle state acquisition unit 74 has acquired the oncoming vehicle 108. If the oncoming vehicle 108 is present, the process advances to step S36, and if there is not the oncoming vehicle 108, the process advances to step S38.

In step S36, the oncoming vehicle state acquisition unit 74 acquires the state of the oncoming vehicle 108 and then, the process advances to step S37. As described above, the oncoming vehicle state acquisition unit 74 acquires as the state of the oncoming vehicle 108, for example, the avoidance trajectory along which the oncoming vehicle 108 travels to avoid the construction area 110, the type of the oncoming vehicle 108, the vehicle speed of the oncoming vehicle 108, or the like.

In step S37, the target stop position setting unit 82 sets the target stop position 114 in accordance with the state of the oncoming vehicle 108, and then the process advances to step S40. The target stop position setting unit 82 sets the target stop position 114 in accordance with the avoidance trajectory of the oncoming vehicle 108 so that the host vehicle 106 stops at the position where the travel of the oncoming vehicle 108 is not interrupted on the basis of the stop position shown by the stop position display 116. Furthermore, the target stop position setting unit 82 sets the target stop position 114 so that the distance between the construction area 110 and the target stop position 114 is longer, as the type of the oncoming vehicle 108 is larger or the speed of the oncoming vehicle 108 is higher. The target stop position setting unit 82 sets the position of the own lane 102 in the length direction and the position of the own lane 102 in the width direction as the target stop position 114.

In addition, the target stop position setting unit 82 corrects the target stop position 114 so that the distance between the construction area 110 and the target stop position 114 is longer, as the oncoming vehicles 108 passing by the host vehicle 106 include more large automobiles until the host vehicle 106 reaches the construction area 110 from the position away from the construction area 110 by the predetermined distance.

In step S38, the construction area shape acquisition unit 76 acquires the shape of the construction area 110 and then, the process advances to step S39. As described above, the construction area shape acquisition unit 76 acquires, as the shape of the construction area 110, the distance L between the part of the construction area 110 on the host vehicle 106 side and the center line 118 of the road 100, the angle of the side surface of the construction area 110 on the host vehicle 106 side with respect to the width direction of the opposite lane 104, the ratio of the construction area 110 to the opposite lane 104 in the width direction, or the like.

In step S39, the target stop position setting unit 82 sets the target stop position 114 in accordance with the shape of the construction area 110, and then the process advances to step S40. The target stop position setting unit 82 sets the target stop position 114 in accordance with the shape of the construction area 110 so that the host vehicle 106 stops at the position where the travel of the oncoming vehicle 108 is not interrupted on the basis of the stop position shown by the stop position display 116. The target stop position setting unit 82 sets the position of the own lane 102 in the length direction and the position of the own lane 102 in the width direction as the target stop position 114.

In addition, the target stop position setting unit 82 corrects the target stop position 114 so that the distance between the construction area 110 and the target stop position 114 is longer, as the oncoming vehicles 108 passing by the host vehicle 106 include more large automobiles until the host vehicle 106 reaches the construction area 110 from the position away from the construction area 110 by the predetermined distance.

In step S40 after the target stop position 114 is set in step S27, step S29, step S33, step S34, step S37, or step S39, the travel control unit 84 controls the acceleration and deceleration of the host vehicle 106 so that the host vehicle 106 stops at the position where the head of the host vehicle 106 comes to the target stop position 114, and thus, the process ends.

### [Operation and Advantageous Effects]

The construction area 110 is set temporarily and even if the stop position display 116 is set before the construction area 110, the stop position shown by the stop position display 116 is not always disposed at the position where the travel of the oncoming vehicle 108 is not interrupted.

In view of the above, in the vehicle control device 10 according to the present embodiment, the target stop position setting unit 82 sets the target stop position 114 in accordance with the acquired avoidance trajectory of the oncoming vehicle 108, type of the oncoming vehicle 108, vehicle speed of the oncoming vehicle 108, or shape of the construction area 110 on the basis of the stop position shown by the stop position display 116. In addition, the travel control unit 84 controls the acceleration and deceleration of the host vehicle 106 so that the host vehicle 106 stops at the set target stop position 114. Thus, the vehicle control device 10 can stop the host vehicle 106 before the construction area 110 at the position where the travel of the oncoming vehicle 108 is not interrupted.

The present invention is not limited to the above described embodiment. Various modifications may be made without deviating from the gist of the present invention.

What is claimed is:

1. A vehicle control device configured to perform travel control of a host vehicle automatically at least partially, the vehicle control device comprising:
a construction area acquisition unit configured to acquire a construction area in an opposite lane ahead of the host vehicle;
an oncoming vehicle state acquisition unit configured to acquire at least one piece of information among an avoidance trajectory along which an oncoming vehicle avoids the construction area, a type of the oncoming vehicle, and a vehicle speed of the oncoming vehicle;
a target stop position setting unit configured to, if the construction area is present in the opposite lane ahead of the host vehicle, set a target stop position where the host vehicle stops before the construction area, in accordance with the acquired at least one piece of information among the avoidance trajectory of the oncoming vehicle, the type of the oncoming vehicle, and the vehicle speed of the oncoming vehicle; and
a travel control unit configured to control acceleration and deceleration of the host vehicle so that the host vehicle stops at the set target stop position.

2. A vehicle control device configured to perform travel control of a host vehicle automatically at least partially, the vehicle control device comprising:
a construction area acquisition unit configured to acquire a construction area in an opposite lane ahead of the host vehicle;
a construction area shape acquisition unit configured to acquire a shape of the construction area;
a target stop position setting unit configured to, if the construction area is present in the opposite lane ahead of the host vehicle, set a target stop position where the host vehicle stops before the construction area, in accordance with the acquired shape of the construction area; and
a travel control unit configured to control acceleration and deceleration of the host vehicle so that the host vehicle stops at the set target stop position.

3. The vehicle control device according to claim 1, further comprising:
a construction area shape acquisition unit configured to acquire a shape of the construction area; and
a stop position display acquisition unit configured to acquire a stop position display showing a stop position before the construction area,
wherein the target stop position setting unit is configured to set the target stop position, in accordance with the acquired at least one piece of information among the avoidance trajectory of the oncoming vehicle, the type of the oncoming vehicle, the vehicle speed of the oncoming vehicle, and the shape of the construction area, on a basis of the stop position shown by the acquired stop position display.

4. The vehicle control device according to claim 1, wherein the target stop position setting unit is configured to set the target stop position so that a distance between the construction area and the target stop position is longer, as the acquired type of the oncoming vehicle is larger, or the acquired vehicle speed of the oncoming vehicle is higher.

5. The vehicle control device according to claim 1, wherein the target stop position setting unit is configured to set the target stop position so that a distance between the construction area and the target stop position is longer, as the oncoming vehicles passing by the host vehicle include more large automobiles before the host vehicle reaches the construction area.

6. The vehicle control device according to claim 1, further comprising a construction area shape acquisition unit configured to acquire a shape of the construction area,
wherein the target stop position setting unit is configured to set the target stop position in a width direction of an own lane, in accordance with the acquired at least one piece of information among the avoidance trajectory of the oncoming vehicle, the type of the oncoming vehicle, the vehicle speed of the oncoming vehicle, and the shape of the construction area.

7. The vehicle control device according to claim 1, further comprising a stop position display acquisition unit configured to acquire a stop position display showing a stop position before the construction area,
wherein if the stop position display is acquired, the target stop position setting unit is configured to set the stop position shown by the acquired stop position display as the target stop position.

8. A vehicle control method for performing travel control of a host vehicle automatically at least partially, the vehicle control method comprising:
a construction area acquisition step of acquiring a construction area in an opposite lane ahead of the host vehicle;
an oncoming vehicle state acquisition step of acquiring at least one piece of information among an avoidance trajectory along which the oncoming vehicle avoids the construction area, a type of the oncoming vehicle, and a vehicle speed of the oncoming vehicle;
a target stop position setting step of, if the construction area is present in the opposite lane ahead of the host vehicle, setting a target stop position where the host vehicle stops before the construction area, in accordance with the acquired at least one piece of information among the avoidance trajectory of the oncoming vehicle, the type of the oncoming vehicle, and the vehicle speed of the oncoming vehicle; and
a travel control step of controlling acceleration and deceleration of the host vehicle so that the host vehicle stops at the set target stop position.

9. A vehicle control method for performing travel control of a host vehicle automatically at least partially, the vehicle control method comprising:
a construction area acquisition step of acquiring a construction area in an opposite lane ahead of the host vehicle;
a construction area shape acquisition step of acquiring a shape of the construction area;
a target stop position setting step of, if the construction area is present in the opposite lane ahead of the host vehicle, setting a target stop position where the host vehicle stops before the construction area, in accordance with the acquired shape of the construction area; and
a travel control step of controlling acceleration and deceleration of the host vehicle so that the host vehicle stops at the set target stop position.

10. The vehicle control method according to claim 8, further comprising:
a construction area shape acquisition step of acquiring a shape of the construction area; and
a stop position display acquisition step of acquiring a stop position display showing a stop position before the construction area,
wherein in the target stop position setting step, the target stop position is set, in accordance with the acquired at least one piece of information among the avoidance trajectory of the oncoming vehicle, the type of the oncoming vehicle, the vehicle speed of the oncoming vehicle, and the shape of the construction area, on a basis of the stop position shown by the acquired stop position display.

11. The vehicle control method according to claim 8, wherein in the target stop position setting step, the target stop position is set so that a distance between the construction area and the target stop position is longer, as the acquired type of the oncoming vehicle is larger, or the acquired vehicle speed of the oncoming vehicle is higher.

12. The vehicle control method according to claim 8, wherein in the target stop position setting step, the target stop position is set so that a distance between the construction area and the target stop position is longer, as the oncoming vehicles passing by the host vehicle include more large automobiles before the host vehicle reaches the construction area.

13. The vehicle control method according to claim 8, further comprising a construction area shape acquisition step of acquiring a shape of the construction area,
wherein in the target stop position setting step, the target stop position in a width direction of an own lane is set, in accordance with the acquired at least one piece of information among the avoidance trajectory of the oncoming vehicle, the type of the oncoming vehicle, the vehicle speed of the oncoming vehicle, and the shape of the construction area.

14. The vehicle control method according to claim 8, further comprising a stop position display acquisition step of acquiring a stop position display showing a stop position before the construction area,
wherein if the stop position display is acquired, the stop position shown by the acquired stop position display is set as the target stop position in the target stop position setting step.
